(19) United States
(12) Patent Application Publication
(10) Pub. No.: US 2022/0258194 A1
(43) Pub. Date: Aug. 18, 2022

(54) PRESSURE WASHING SPRAY GUN WITH TRIGGER LOCK

(71) Applicants: Leecurtis Anglin, JR., Auburndale, FL (US); Heng Brennan, Bradenton, FL (US)

(72) Inventors: Leecurtis Anglin, JR., Auburndale, FL (US); Heng Brennan, Bradenton, FL (US)

(21) Appl. No.: 17/484,632

(22) Filed: Sep. 24, 2021

Related U.S. Application Data
(63) Continuation of application No. 29/804,017, filed on Aug. 17, 2021.
(60) Provisional application No. 63/234,219, filed on Aug. 17, 2021.
(60) Provisional application No. 63/082,781, filed on Sep. 24, 2020.

(51) Int. Cl. B05B 12/00; B05B 9/01; B08B 3/02

(52) U.S. Cl. CPC B05B 12/0026; B08B 3/028; B05B 9/01

(57) ABSTRACT

Described are trigger locks for pressure washing surface cleaner or general pressure washer spray guns.

### RELATED APPLICATIONS

This application claims the benefit of U.S. Application No. 63/234,219, entitled “Pressure Washing Spray Gun With Trigger Lock,” and filed on Aug. 17, 2021, and U.S. Application No. 63/082,781, entitled “Pressure Washing Surface Cleaner Spray Gun Trigger Lock,” and filed on Sep. 24, 2020, both of which are incorporated herein in their entirety.

### TECHNICAL FIELD

Some implementations relate generally to pressure washers, and more particularly, to trigger locks for pressure washing surface cleaner spray guns.

### BACKGROUND

Personnel operating pressure washers may need to engage the pressure washing surface cleaner spray gun trigger for extended periods of time. The force required to keep the trigger of a spray gun engaged may cause fatigue, strain, and potential injury on the hands or arm of the operator.

A need may exist for a pressure washing surface cleaner or general pressure washer spray gun trigger lock to keep the trigger engaged without requiring hand force from the pressure washer operator.

### SUMMARY

Some implementations can include a pressure washing surface cleaner or general pressure washer spray gun comprising a spray gun handle portion, a trigger constructed and arranged to transition between an off position and an on position, and a trigger lock coupled to the spray gun handle portion and operable to engage the trigger when the trigger is in the on position and the trigger lock is moved to a locked position, wherein the trigger lock is operable to disengage the trigger when the trigger lock is moved to an unlocked position.

Some implementations can include a pressure washing surface cleaner or general pressure washer spray gun comprising a spray gun handle portion, a trigger constructed and arranged to transition between an off position and an on position, a trigger safety lock mounted on a first side of the trigger and constructed and arranged to prevent the trigger from being actuated when the trigger safety lock is rotated to a safety position and engages a trigger safety lock detent and to permit the trigger to be actuated when the trigger lock is in an operating position, and a trigger operating lock mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position on the trigger to permit the trigger to be released.

Some implementations can include a pressure washing surface cleaner or general pressure washer spray gun comprising a spray gun handle portion, a trigger constructed and arranged to transition between an off position and an on position, a trigger safety lock mounted on a first side of the trigger and constructed and arranged to prevent the trigger from being actuated when the trigger safety lock is rotated to a safety position and engages a trigger safety lock detent and to permit the trigger to be actuated when the trigger lock is in an operating position, and a trigger operating lock having a pivot point mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position to permit the trigger to be released.

Some implementations can include a linear pressure washing surface cleaner or general pressure washer spray gun comprising a spray gun handle portion, a trigger constructed and arranged to transition between an off position and an on position, a trigger safety lock mounted on a first side of the trigger and constructed and arranged to prevent the trigger from being actuated when the trigger safety lock is rotated to a safety position and engages a trigger safety lock detent and to permit the trigger to be actuated when the trigger lock is in an operating position, and a trigger operating lock mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position on the trigger to permit the trigger to be released.

### BRIEF DESCRIPTION OF THE DRAWINGS

FIG. 1 is a diagram of an example pressure washing surface cleaner or general pressure washer spray gun with trigger lock in accordance with some implementations.

FIG. 2 is a diagram of an example pressure washing surface cleaner or general pressure washer spray gun with trigger lock in accordance with some implementations.

FIG. 3 is a diagram of an example linear or in-line type pressure washing surface cleaner or general pressure washer spray gun with trigger lock in accordance with some implementations.

FIG. 4 is a diagram of an example pressure washing surface cleaner or general pressure washer spray gun with trigger lock and safety strap in accordance with some implementations.

FIG. 5 is a diagram of an example linear or in-line type pressure washing surface cleaner spray gun with trigger lock and safety strap in accordance with some implementations.

FIGS. 6-7 are diagrams of an example linear or in-line type pressure washing surface cleaner spray gun with trigger lock and safety strap in accordance with some implementations.

FIGS. 8-16 are diagrams of an example pressure washing surface cleaner or general pressure washer spray gun with trigger lock and safety release in accordance with some implementations.

FIGS. 17-20 are diagrams of an example pressure washing surface cleaner or general pressure washer spray gun with trigger lock and safety release in accordance with some implementations.

FIGS. 21-25 are diagrams of an example linear or in-line type pressure washing surface cleaner spray gun with trigger lock and safety release in accordance with some implementations.

### DETAILED DESCRIPTION

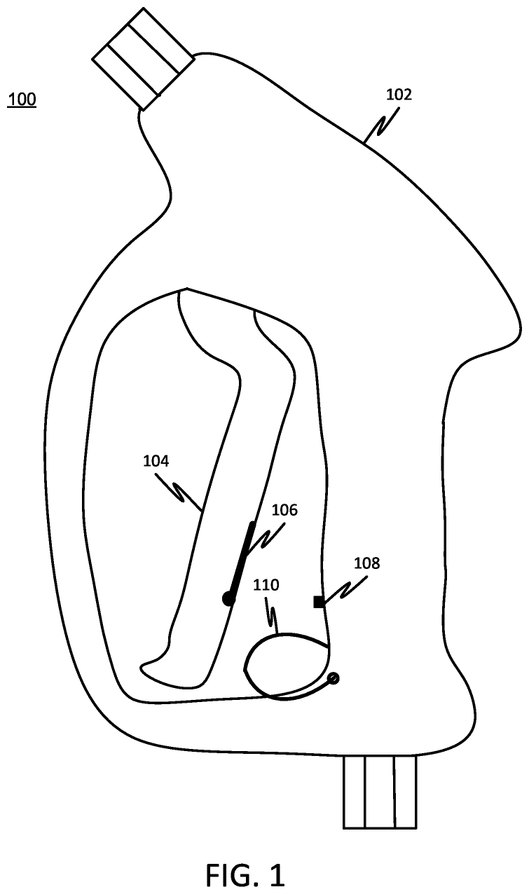

In general, the example implementations shown in FIGS. 1-6 include a pressure washing surface cleaner or general pressure washer spray gun with operating lock that can keep the trigger of the pressure washing surface cleaner or general pressure washer spray gun engaged without requiring the operator to continuously apply hand pressure to the trigger. The operating trigger lock can help relieve stress, tension, and potential injury to the hands or forearm of an operator of the pressure washing surface cleaner or general pressure washer spray gun.

FIG. 1 is a diagram of an example pressure washing surface cleaner or general pressure washer spray gun 100 with trigger lock in accordance with some implementations. The spray gun 100 includes a spray gun handle 102, a trigger 104, trigger safety lock 106, a trigger safety lock detent 108, a trigger operating lock 110, and a trigger operating lock detent 112. The spray gun 100 includes a spray gun handle 102, a trigger 104 constructed and arranged to transition between an off position and an on position; a trigger safety lock 106 mounted on a first side of the trigger 104 and constructed and arranged to prevent the trigger 104 from being actuated when the trigger safety lock 106 is rotated to a safety position and engages a trigger safety lock detent 108 and to prevent the trigger 104 from being actuated when the trigger safety lock 106 is in an operating position; and a trigger operating lock 110 mounted on a second side of the trigger opposite the first side and constructed and arranged to keep the trigger actuated when the trigger operating lock 110 is rotated to a locked position to engage a trigger operating lock detent 112 when the trigger 104 is actuated, and wherein the trigger operating lock 110 is rotatable to a stowed position on the trigger 104 to permit the trigger 104 to be released.

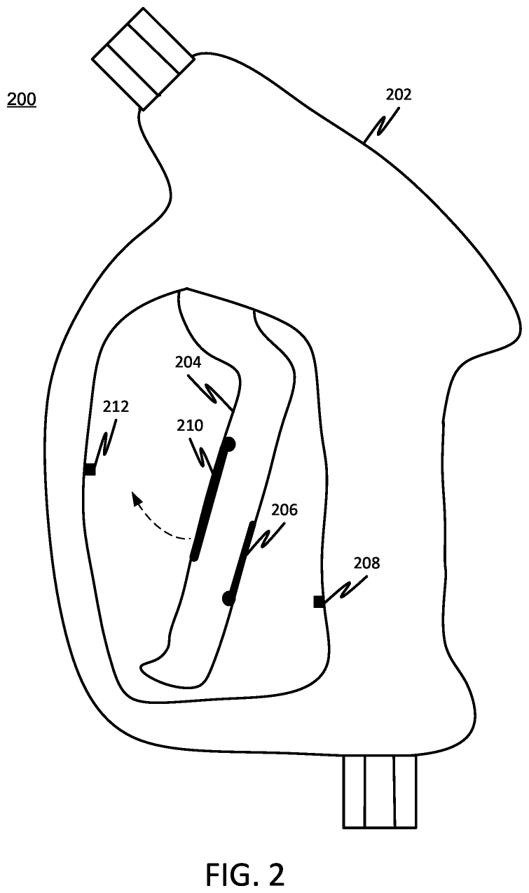

FIG. 2 is a diagram of an example pressure washing surface cleaner or general pressure washer spray gun 200 with trigger lock in accordance with some implementations. The pressure washing surface cleaner or general pressure washer spray gun 200 includes a spray gun handle portion 202, a trigger 204 constructed and arranged to transition between an off position and an on position, a trigger safety lock 206 mounted on a first side of the trigger 204 and constructed and arranged to prevent the trigger 204 from being actuated when the trigger safety lock 206 is rotated to a safety position and to permit the trigger 204 to be actuated when the trigger safety lock 306 is in an operating position. The spray gun 200 includes a trigger operating lock 208 having a pivot point mounted on a second side of the trigger 204 opposite the first side and constructed and arranged to keep the trigger 204 actuated when the trigger operating lock 208 is rotated to a locked position to engage a trigger operating lock detent 210 when the trigger 204 is actuated, and wherein the trigger operating lock 208 is rotatable to a stowed position to permit the trigger 204 to be released.

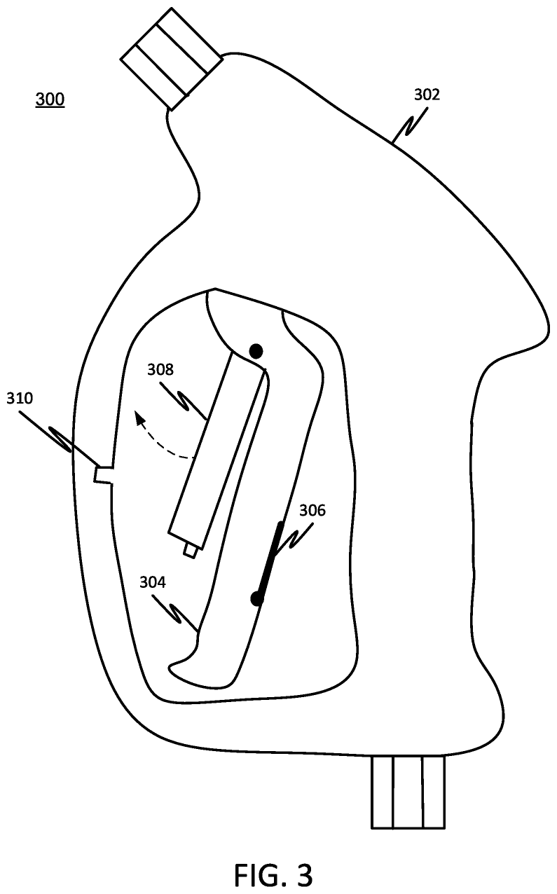

FIG. 3 is a diagram of an example linear or in-line type pressure washing surface cleaner spray gun 300 with trigger lock in accordance with some implementations. The linear pressure washing surface cleaner spray gun 300 includes a spray gun handle portion 302, a trigger 304 constructed and arranged to transition between an off position and an on position, a trigger safety lock 306 mounted on a first side of the trigger 304 and constructed and arranged to prevent the trigger 304 from being actuated when the trigger safety lock 306 is rotated to a safety position and engages a trigger safety lock detent 308 and to permit the trigger 304 to be actuated when the trigger safety lock 306 is in an operating position, and a trigger operating lock 310 mounted on a second side of the trigger 304 opposite the first side and constructed and arranged to keep the trigger 304 actuated when the trigger operating lock 310 is rotated to a locked position to engage a trigger operating lock detent 312 when the trigger is actuated, and wherein the trigger operating lock 310 is rotatable to a stowed position on the trigger 304 to permit the trigger 304 to be released.

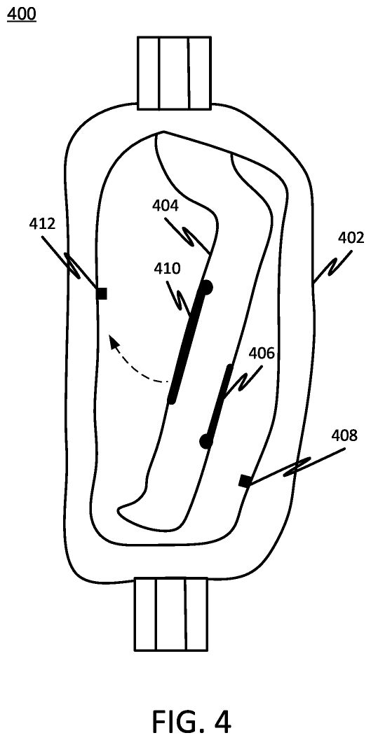

FIG. 4 is a diagram of an example pressure washing surface or general pressure washer cleaner spray gun 400 with trigger lock and safety strap in accordance with some implementations. The spray gun 400 includes a spray gun handle 402, a trigger 404, trigger safety lock 406, a trigger safety lock detent 408, a trigger operating lock 410, a trigger operating lock detent 412, a safety strap anchor 414, a safety strap 416, and a safety strap loop handle 418.

The safety strap 416 is constructed to disengage the trigger operating lock 410 if the spray gun is dropped or separated from the user beyond the length of the strap.

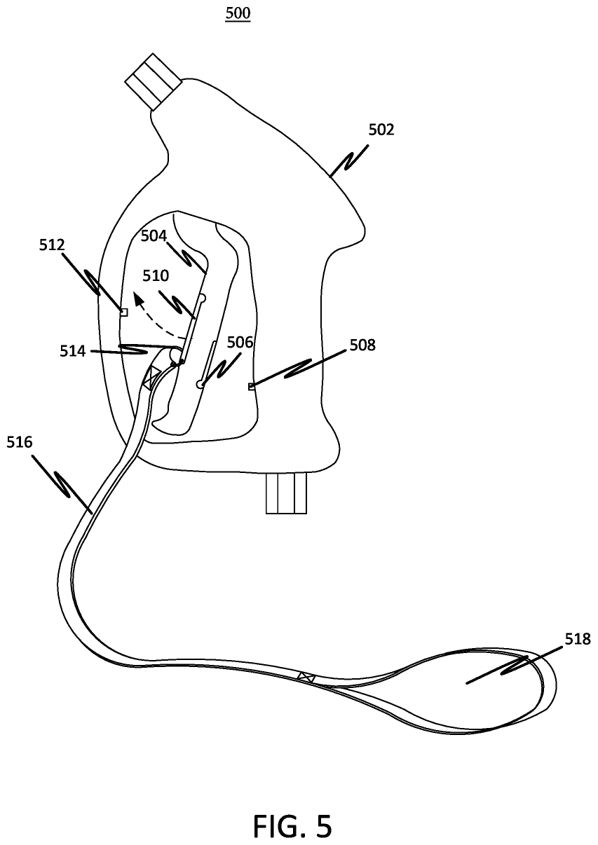

FIG. 5 is a diagram of an example linear or in-line type pressure washing surface cleaner spray gun 500 with trigger lock and safety strap in accordance with some implementations. The spray gun 500 includes a spray gun handle 502, a trigger 504, trigger safety lock 506, a trigger safety lock detent 508, a trigger operating lock 510, a trigger operating lock detent 512, a safety strap anchor 514, a safety strap 516, and a safety strap loop handle 518.

FIG. 5 shows the linear or in-line type pressure washing surface cleaner spray gun with trigger lock and safety strap in the unlocked position.

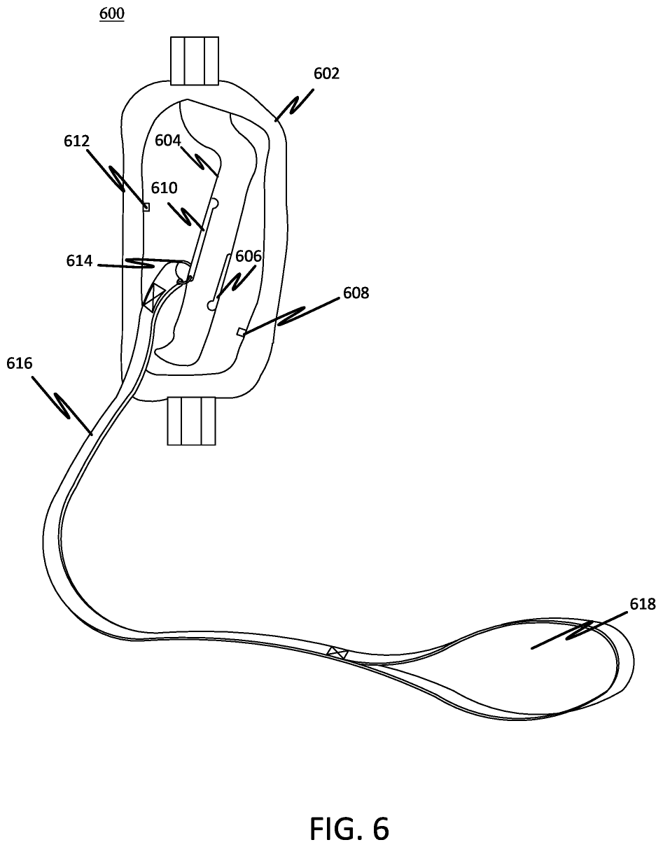

FIG. 6 is a diagram of an example linear or in-line type pressure washing surface cleaner or general pressure washer spray gun 600 with trigger lock and safety strap in accordance with some implementations. The spray gun 600 includes a spray gun handle 602, a trigger 604, trigger safety lock 606, a trigger safety lock detent 608, a trigger operating lock 610, a trigger operating lock detent 612, a safety strap anchor 614, a safety strap 616, and a safety strap loop handle 618.

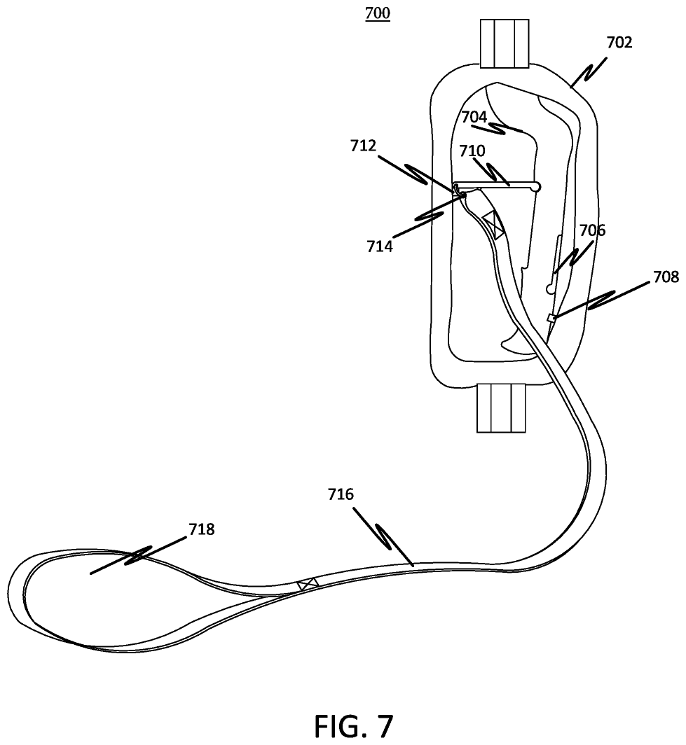

FIGS. 6 and 7 show the linear or in-line type pressure washing surface cleaner spray gun with trigger lock and safety strap in the locked position.

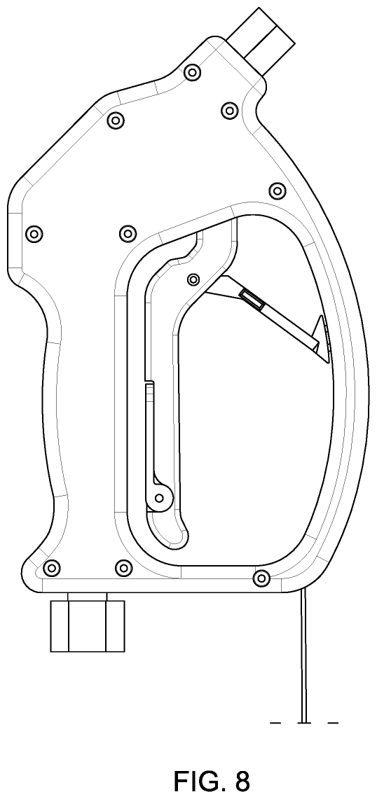

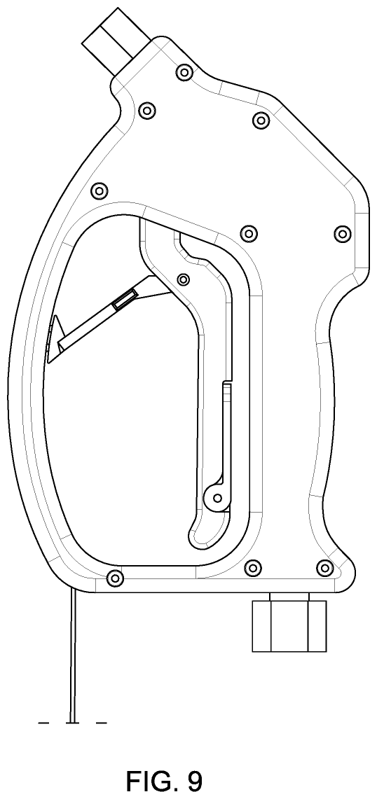

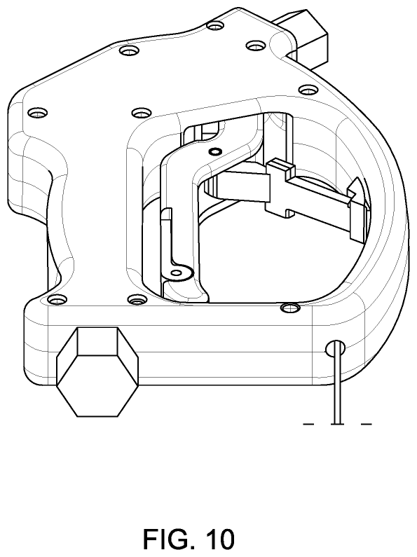

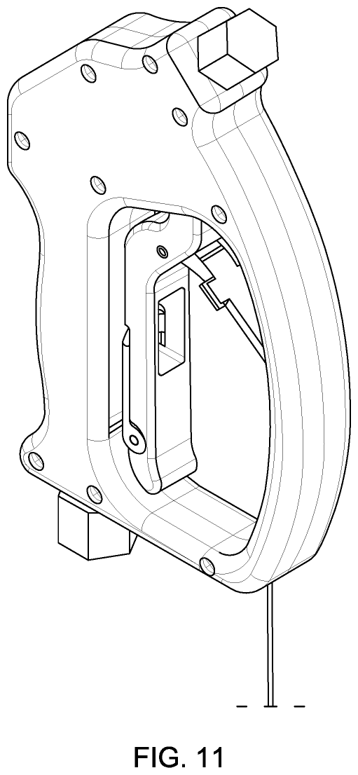

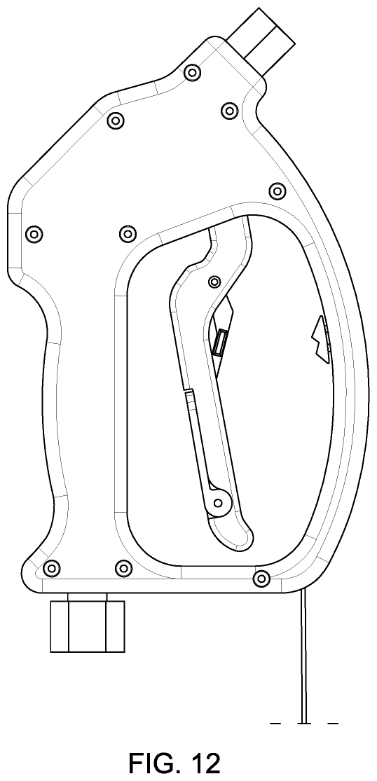

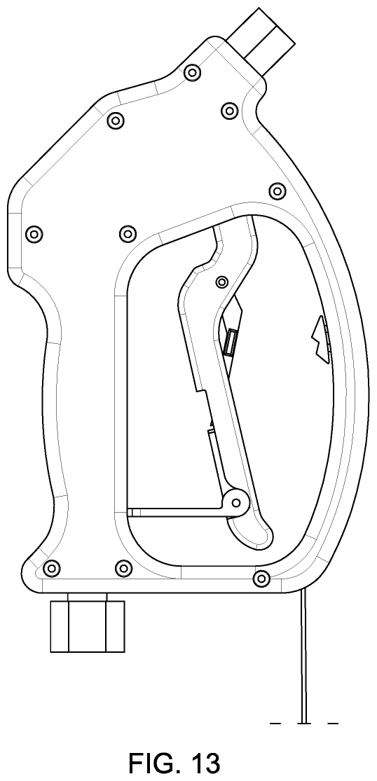

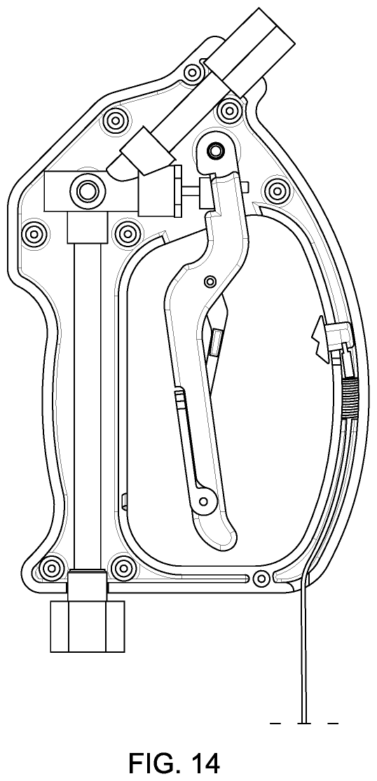

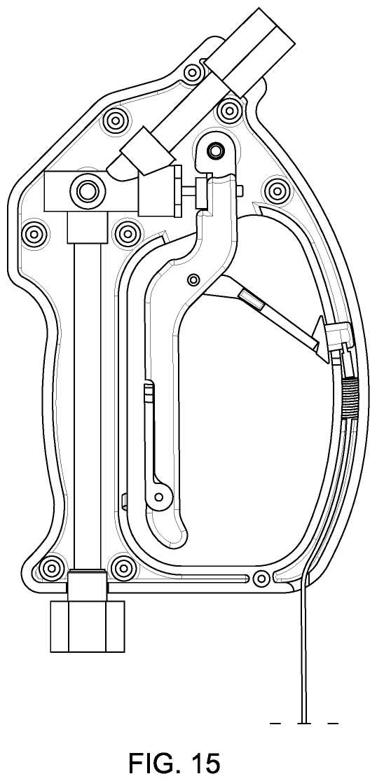

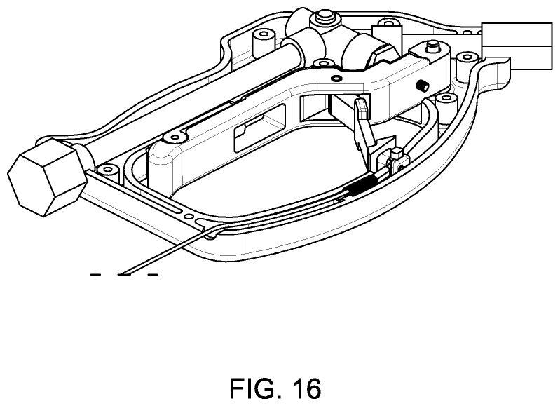

FIGS. 8-16 are diagrams of an example pressure washing surface cleaner or general pressure washer spray gun with trigger lock and safety release in accordance with some implementations. In particular, a trigger lock is engageable with a spring-loaded catch on the spray gun. The spring-loaded catch is coupled to the safety release such that the spring loading provides sufficient force for the catch to hold the trigger lock in place. When the safety release pulls on the spring-loaded catch, the force of the pull from the safety release causes the spring-loaded catch to change position and release the trigger lock causing the spray gun to deactivate.

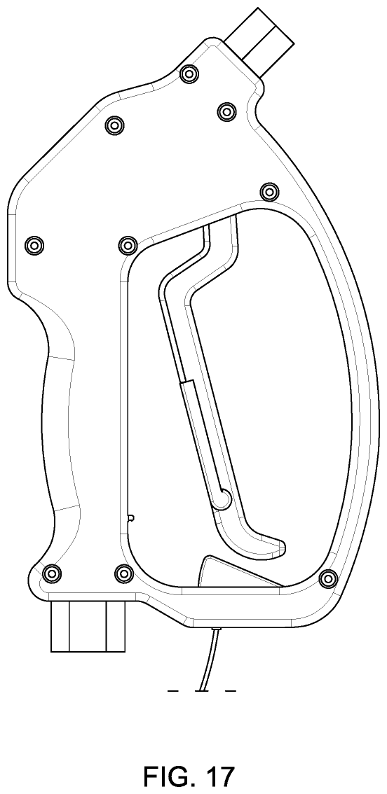

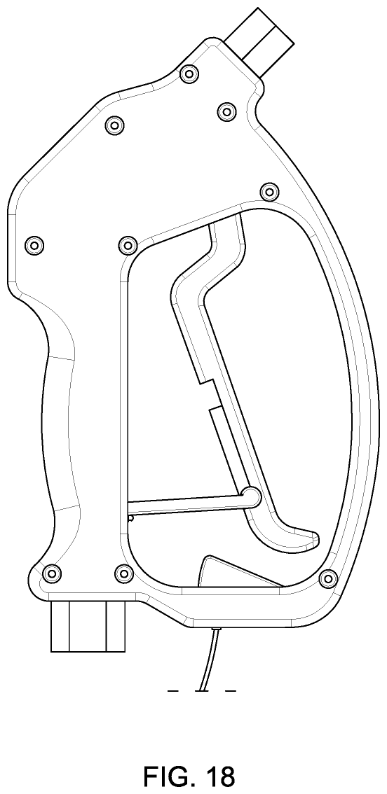

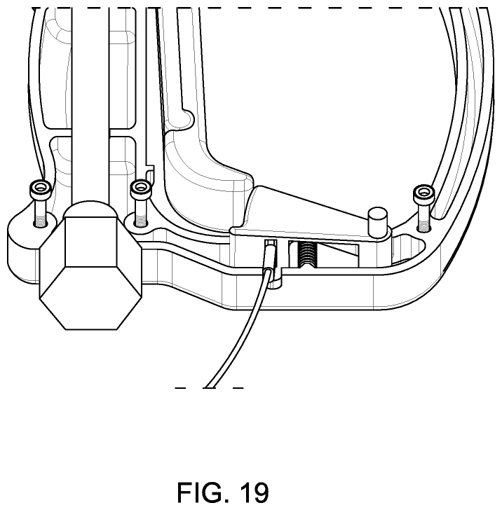

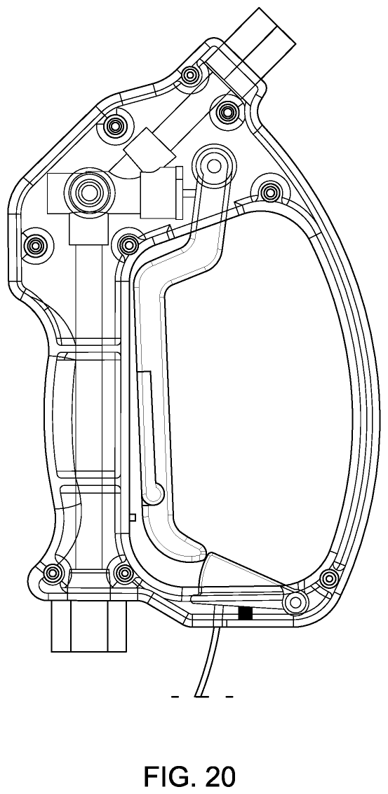

FIGS. 17-20 are diagrams of an example pressure washing surface cleaner or general pressure washer spray gun with trigger lock and safety release in accordance with some implementations. In particular, the spray gun trigger is engageable with a spring-loaded catch on the spray gun when the trigger is engaged to a position beyond the spring-loaded catch. The spring-loaded catch is coupled to the safety release such that the spring loading provides sufficient force for the catch to hold the trigger in place. When the safety release pulls on the spring-loaded catch, the force of the pull from the safety release causes the spring-loaded catch to change position and release the trigger causing the spray gun to deactivate.

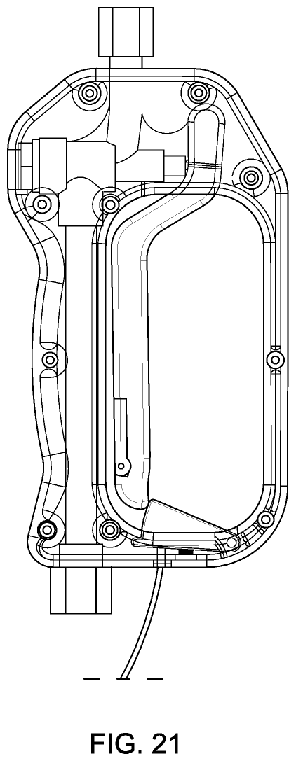

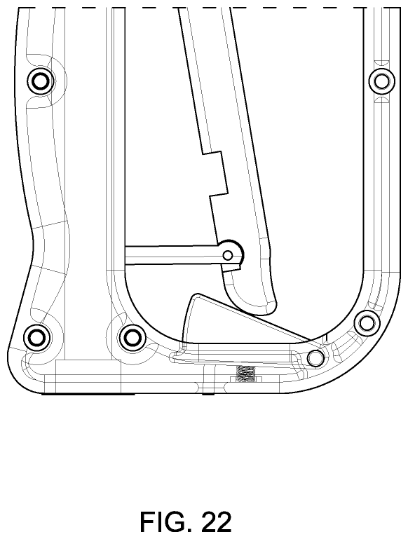

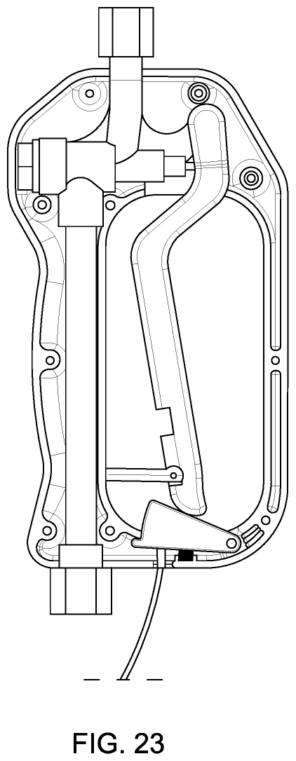

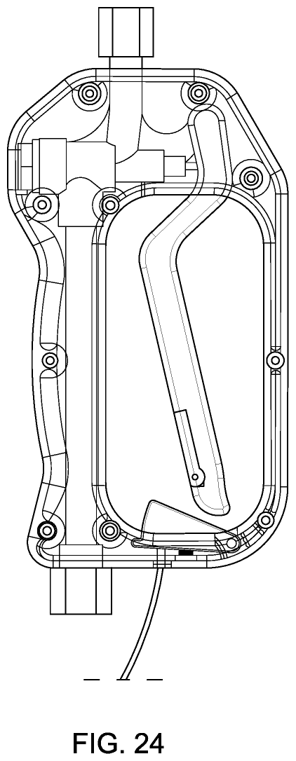

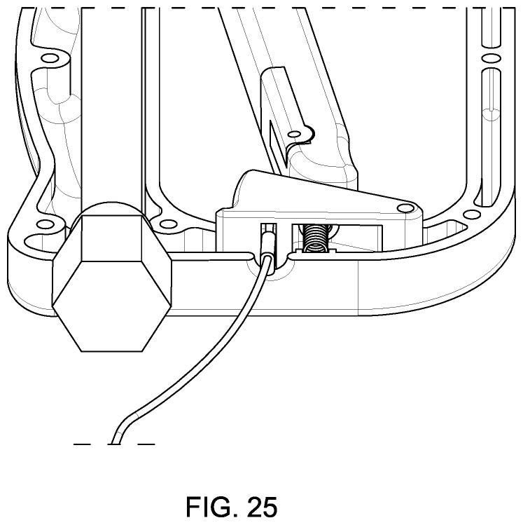

FIGS. 21-25 are diagrams of an example linear or in-line type pressure washing surface cleaner spray gun with trigger lock and safety release in accordance with some implementations. In particular, the spray gun trigger is engageable with a spring-loaded catch on the spray gun when the trigger is engaged to a position beyond the spring-loaded catch. The spring-loaded catch is coupled to the safety release such that the spring loading provides sufficient force for the catch to hold the trigger in place. When the safety release pulls on the spring-loaded catch, the force of the pull from the safety release causes the spring-loaded catch to change position and release the trigger causing the spray gun to deactivate.

In addition to the spring-loaded catch, the implementations in FIGS. 8-25 can also include safety lock to prevent the trigger from being engaged.

It is, therefore, apparent that there is provided, in accordance with the various implementations disclosed herein, pressure washing surface cleaner spray guns with trigger locks.

While the disclosed subject matter has been described in conjunction with a number of embodiments or implementations, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A pressure washing surface cleaner or general pressure washer spray gun comprising:
a spray gun handle portion;
a trigger constructed and arranged to transition between an off position and an on position; and
a trigger lock coupled to the spray gun handle portion and operable to engage the trigger when the trigger is in the on position and the trigger lock is moved to a locked position, wherein the trigger lock is operable to disengage the trigger when the trigger lock is moved to an unlocked position.

2. A pressure washing surface cleaner or general pressure washer spray gun comprising:
a spray gun handle portion;
a trigger constructed and arranged to transition between an off position and an on position;
a trigger safety lock mounted on a first side of the trigger and constructed and arranged to prevent the trigger from being actuated when the trigger safety lock is rotated to a safety position and engages a trigger safety lock detent to permit the trigger to be actuated when the trigger safety lock is in an operating position;
a trigger operating lock mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position on the trigger to permit the trigger to be released; and
a safety strap having a length, a first end, and a second end, wherein the first end is coupled to the trigger operating lock and the second end having a loop handle configured to secure the safety strap to a hand of a user, wherein the safety strap is constructed to disengage the trigger operating lock if the spray gun is dropped or separated from the user beyond the length of the strap.

3. A pressure washing surface cleaner or general pressure washer spray gun comprising:
a spray gun handle portion;
a trigger constructed and arranged to transition between an off position and an on position;
a trigger safety lock mounted on a first side of the trigger and constructed and arranged to prevent the trigger from being actuated when the trigger safety lock is rotated to a safety position and engages a trigger safety lock detent and to permit the trigger to be actuated when the trigger safety lock is in an operating position; and
a trigger operating lock having a pivot point mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position to permit the trigger to be released.

4. A linear pressure washing surface cleaner or general pressure washer spray gun comprising:
a spray gun handle portion;
a trigger constructed and arranged to transition between an off position and an on position;
a trigger safety lock mounted on a first side of the trigger and constructed and arranged to prevent the trigger from being actuated when the trigger safety lock is rotated to a safety position and engages a trigger safety lock detent and to permit the trigger to be actuated when the trigger lock is in an operating position;
a trigger operating lock mounted on a second side of the trigger opposite the first side and constructed and arranged to keep the trigger actuated when the trigger operating lock is rotated to a locked position to engage a trigger operating lock detent when the trigger is actuated, and wherein the trigger operating lock is rotatable to a stowed position on the trigger to permit the trigger to be released; and
a safety strap having a length, a first end, and a second end, wherein the first end is coupled to the trigger operating lock and the second end having a loop handle configured to secure the safety strap to a hand of a user, wherein the safety strap is constructed to disengage the trigger operating lock if the spray gun is dropped or separated from the user beyond the length of the strap.
